(19) United States
(12) Patent Application Publication
(10) Pub. No.: US 2013/0220148 A1
(43) Pub. Date: Aug. 29, 2013

(54) Tuna Squeezer

(71) Applicant: Rick A. Freeland, Dublin, CA (US)

(72) Inventor: Rick A. Freeland, Dublin, CA (US)

(21) Appl. No.: 13/779,538

(22) Filed: Feb. 27, 2013

Related U.S. Application Data
(60) Provisional application No. 61/634,311, filed on Feb. 27, 2012.

(51) Int. Cl. A47J 43/28

(52) U.S. Cl. CPC A47J 43/286
USPC 100/110

(57) ABSTRACT

The invention provides a durably constructed plastic kitchen utensil used to quickly strain the liquids from canned foods, effectively eliminating the risk of spilling the liquid on their hands or countertops. The invention provides a disc having spaced apart holes and a handle attached to the disc. Attached to one end of the handle is a magnet strong enough to lift the can lid out of an already opened can.

### CLAIM OF PRIORITY

This patent application claims priority under 35 USC 119 (e) (1) from U.S. Provisional Patent Application Ser. No. 61/634,311 filed Feb. 27, 2012, of common inventorship herewith entitled, “Tuna Squeezer.”

### FIELD OF THE INVENTION

The present invention pertains to the field of kitchen accessories, and more specifically to the field of accessories for straining juices from a canned food.

### BACKGROUND OF THE INVENTION

The prior art has put forth several designs for canned food accessories for draining juices. Among these are:

U.S. Pat. No. 3,995,544 to D. Gray Farley describes a tuna squeezer and strainer utensil comprising a cup shaped member having a cylindrical wall conforming to the internal diameter of a standard can size. An end circular wall is perforated to provide permeability to liquid while blocking passage of solids. The side walls comprise support tabs which project radially outward from the side walls to provide grasping of the press whereby the press can be inserted into a can, compressed and then inverted and rotated to permit unimpeded drainage from the can.

U.S. Patent Des. 311,116 to Robert A. Pentland describes an ornamental design for a tuna can squeezer comprising one end with tong handles and the other end containing attached lids. One lid holds the base of a can while the other lid is inserted above the canned food and compressed against the food to allow drainage of the liquid when grasping the can and turning it sideways of downward.

U.S. Pat. No. 6,422,138 to Timothy Ballard describes a canned food pressing device including a cylindrical member having an upper end, a lower end, a cylindrical side wall there between, and a diameter slightly less than a tuna fish can. A cylindrical flange member is secured to the side wall intermediate to the upper and lower ends. This flange member extends outwardly beyond the external diameter of the cylindrical member to provide a shield for the water or oil being drained from the tuna fish.

None of these prior art references describe the present invention.

### SUMMARY OF THE INVENTION

It is an object of the present invention to provide a canned food accessory for straining and draining liquids and juices from solid foods.

### BRIEF DESCRIPTION OF THE DRAWINGS

FIG. 1 is a top diagonal illustrative view showing a magnet on a plastic and functional T designed accessory.

FIG. 2 is a top diagonal functional view showing the present invention inserted into the top of a tuna fish can.

FIG. 3 shows a front view of an alternative design for the handle of the invention.

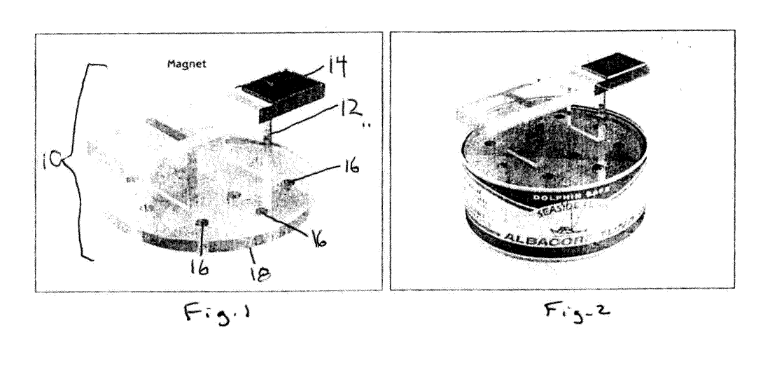

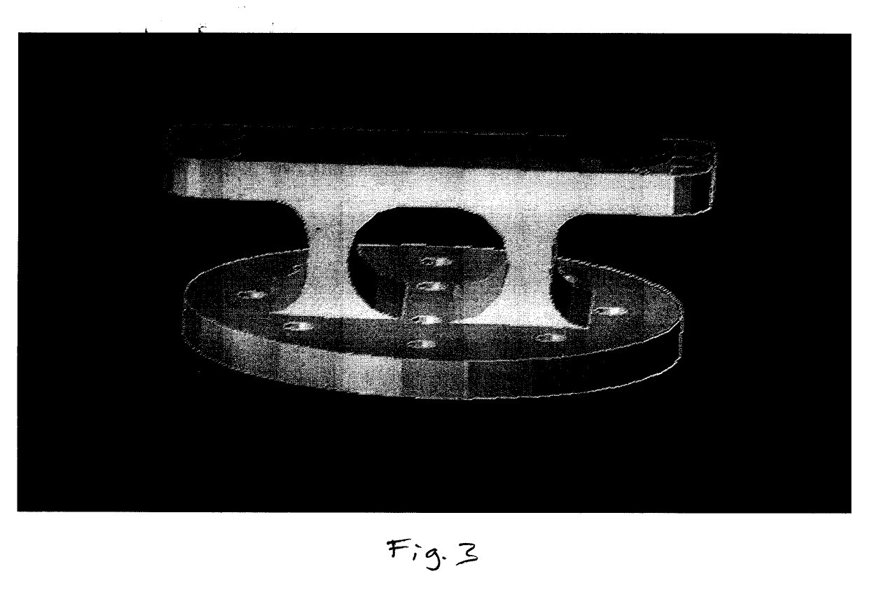

### DETAILED DESCRIPTION BF THE INVENTION

One of the biggest inconveniences about canned products is the usual cleanup that follows the opening of the can. We're all familiar with this nuisance. A person sets out to make a tuna sandwich, enjoy a fruit cocktail or any number of available canned goods. Then that person is trying to scrub the oil or other liquids from their hands. Tuna oil is infamous for leaving a terrible fishy odor even after intense cleansing. Most canned products offer no straining system for the solids and liquids within the can and the consumer uses their fingers to press in the can top and drain the liquid. This method is extremely messy and inefficient at filtering out all of the liquid. The consumer redrains the can multiple times before using its contents. What's even worse is when the can top becomes wedged in the can and any particles or bacteria on top of the lid are now mixed with the food, possibly causing contamination. The consumer struggles to remove the obstructing lid which often results in a variety of cuts. When one finally pries out the can lid, a majority of the edible food product has spilled out during the process. Current kitchen utensils seem unable to address this problem. While can openers allow users to easily open the product, they do nothing about the liquid and oils left inside. Colanders allow consumers to drain the can but are bulky and cumbersome and often have large holes through which some of the product falls out.

The present invention, hereinafter referred to as the Tuna Squeezer, is a durably constructed plastic kitchen utensil used to quickly strain the liquids from canned foods. The present invention provides consumers with a simple means of draining all the excess liquid from a canned product, effectively eliminating the risk of spilling the liquid on their hands or countertops.

The present invention is a hand held plastic straining device [10] featuring a circular disc having spaced apart holes therein and a conveniently placed handle [12] attached to the disc for easy use and a magnet [14] to remove the can lid after use. The magnet is placed on the end of the handle. Attached to the handle is a disc, having spaced apart holes to allow the egress of the liquid from the can when pressed. The base of the Tuna Squeezer is circular in shape and measures approximately three and one half inches in diameter. Since the base presses the liquid out of the can, it comprises a number of small holes [16] to allow the liquid to pass through it easily. Positioned directly over the center of the base is a conveniently placed handle [12]. This formidable grip allows users to apply pressure to the base of the Tuna Squeezer to drain liquid from a can. Attached to one end of this handle is a magnet [14] strong enough to lift the can lid out of an already opened can. The handle can be of a T-configuration, or a 2-part T configuration, as shown, Alternatively, the ends of the handle can be attached to the edges of the disc so the handle crosses the diameter of the disc.

The base [18] of the Tuna Squeezer is even and flat, so the user easily strains out liquid without having to use the can lid, sparing the user the risk of the lid becoming stuck in the can and the hassle of working it back out. Use of the Tuna Squeezer also prevents potential injury by cutting ones fingers when removing the sharp lid from the inside of the can. More importantly, since the Tuna Squeezer drains all liquid from a canned product, users only need to drain once, saving time and effort. The Tuna Squeezer eliminates the risk of losing some food product while straining the liquid out of it. A convenient hand held straining utensil that provides consumers with an easy method of eliminating excess liquid from canned products, the Tuna Squeezer will find a wide and enthusiastic reception from a variety of markets and consumers.

The present invention can be sized according to the needs of the user. This includes large commercial cans as well as a variety of consumer sized cans. This device can also be used for a variety of wet packed material where it is desirous to drain the excess liquid therefrom.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A canned food device for straining and draining liquids and juices from solid foods, comprising a hand held plastic straining utensil featuring a circular disc having spaced apart holes therein and a handle attached to the disc to allow the user to grip the handle above the disc.

2. The canned food device of claim 1 further having a magnet attached to one end of the handle.

3. The canned food device of claim 2 wherein the disc is circular in shape and measures approximately three and one half inches in diameter.

4. The device of claim 1 wherein the handle has a first end and a second end and the first end is attached to the edge of the disc and the second end is attached to the edge of the disc across the diameter of the disc from the attachment of the first end.
